(19) United States
(12) Patent Application Publication
(10) Pub. No.: US 2009/0262306 A1
(43) Pub. Date: Oct. 22, 2009

(54) System and Method for Integration of a Projector and Information Handling System in a Common Chassis

(76) Inventors: Liam B. Quinn, Austin, TX (US); Samuel Nicklaus D'Alessio, Round Rock, TX (US); Bruce Montag, Austin, TX (US)

Correspondence Address: HAMILTON & TERRILE, LLP, P.O. BOX 203518, AUSTIN, TX, 78720, US

(21) Appl. No.: 12/103,791

(22) Filed: Apr. 16, 2008

(51) Int. Cl. G03B 23/00; G06T 1/00

(52) U.S. Cl. 353/25; 345/660; 345/501

(57) ABSTRACT

A projector integrates in a portable information handling system housing with a light modulator of the projector receiving display information directly from a graphics processor of the information handling system, thus eliminating the need for a display controller to control formation of a visual image at the light modulator. The graphics processor performs scaling, color correction and brightness control functions for images presented by the projector, as well as keystone correction and image rotation to correct image offset presented due to the orientation of the information handling system chassis or lid.

### BACKGROUND OF THE INVENTION

1. Field of the Invention

The present invention relates in general to the field of information handling system displays, and more particularly to a system and method for integration of a projector and information handling system in a common chassis.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A consideration for end users in the selection and use of information handling systems is the presentation of information generated by information handling systems. Conventional desktop or tower information handling systems typically include an external port that outputs visual information for presentation at an external display device, such as a cathode ray tube (CRT) display, a flat panel liquid crystal display (LCD), or a projector. In the past, industry has cooperated to develop standardized display connectors, such as VGA connectors, so that compliant information handling systems can interface with compliant display devices from a variety of manufacturers. For example, information generated by an application running on a central processing unit (CPU) is sent across a bus to a graphics processing unit (GPU) which further processes the information to generate visual images at a pixel level for communication to an external display through a cable coupled to the connector. Portable information handling systems eliminate the cable by integrating a display in the housing of the information handling system, such as in a rotationally coupled lid. Portable information handling systems typically also do include a connector to support an external display. Often, the connector is used to interface with an external projector to present visual images on a screen, such as for slide shows that accompany speeches or sales pitches.

Connecting an external display device, such as a projector, seems easy to an end user, but a variety of processing steps are typically involved. Within the information handling system, a signal representing visual information is prepared by the GPU and forwarded to the connector, such as a VGA, DVI or DisplayPort connector. The signal proceeds through an external cable to a port of the projector where a display input front end translates the signal to a transistor-transistor level (TTL) signal for communication to a display controller. The display controller translates the TTL signal into a format used by the projector, such as a Low Voltage Differential Signal (LVDS), for communication to a light modulator. The light modulator forms the visual image using pixel information from the LVDS signal and a light source focused through the light modulator and a lens projects the image away from the projector. The light source is typically a bright lamp, such as a halogen lamp, although smaller projectors rely on LED and laser light sources. The display controller performs scaling so that the visual image defined by the visual information fits into the image size presented by the projector.

### SUMMARY OF THE INVENTION

Therefore, a need has arisen for a system and method that integrates a projector into a portable information handling system to present information generated by a graphics processor.

In accordance with the present invention, a system and method are provided which substantially reduce the disadvantages and problems associated with previous methods and systems for presenting information from an information handling system with a projector. A projector is integrated into a portable information handling system chassis so that a light modulator of the projector receives display information from the graphics processor of the information handling system so that a separate display controller is not needed at the projector.

More specifically, an information handling system has a processor that runs an operating system and applications to generate visual information. The visual information is provided to a graphics processor for processing into display information that has pixel values for a display to present a visual image. Both an integrated display, such as an LCD, and an integrated projector interface with the graphics processor to receive the display information. The integrated projector has a light modulator that creates a visual image from the display information, a light source that directs light at the light modulator and optics that accept light from the light modulator to project an image distal the information handling system. An alignment module associated with the projector determines an image offset for the image so that the graphics process can perform a correction that presents the image at the light modulator in an upright presentation.

The present invention provides a number of important technical advantages. One example of an important technical advantage is that a projector integrated in an information handling system receives pixel information directly from a graphics processor of the information handling system to provide a compact projection solution. Directly interfacing the graphics processor to the projector to a light modulator of the projector eliminates the need for a display front end and display controller with the graphics processor performing scaling, color correction and brightness control functions in the place of the display controller. The graphics processor also automatically provides other image correction processing for ease of use, such as keystone correction of the image and rotation of the image based on the angle at which the projector is set.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having an integrated projector;

FIG. 2 depicts an information handling system having a projector integrated at the rotational axis of a housing lid; and

FIG. 3 depicts an information handling system having a projector integrated in a housing lid distal the rotational axis.

### DETAILED DESCRIPTION

Integration of a projector in a portable information handling system is supported with graphics processing native to the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

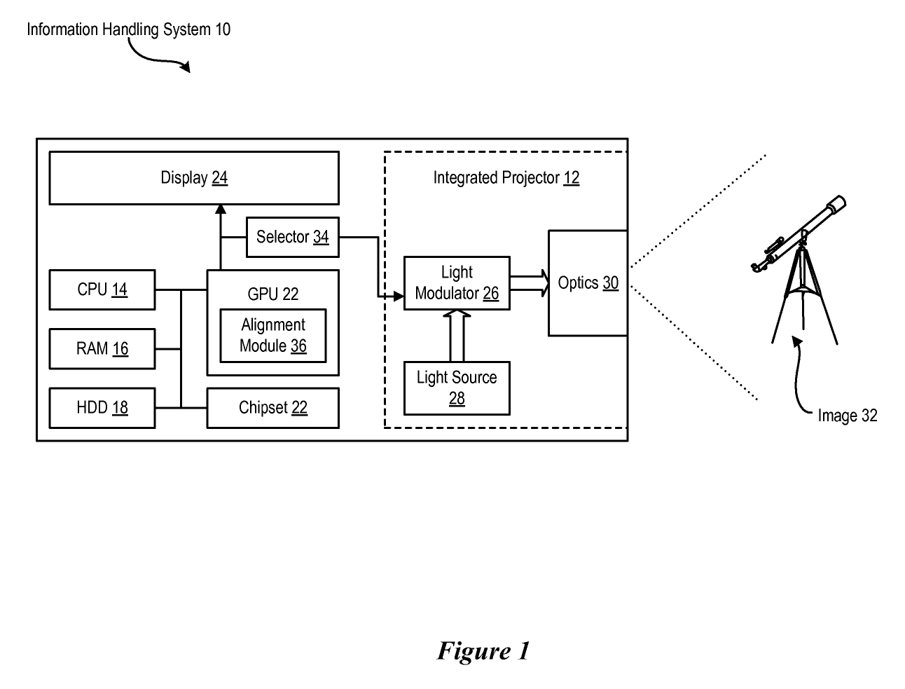

Referring now to FIG. 1, a block diagram depicts an information handling system 10 having an integrated projector 12. Information handling system 10 includes a variety of processing components that cooperate to process information, such as a CPU 14, RAM 16, a hard disk drive (HDD) 18, a chipset 20 and a graphics processing unit (GPU) 22. For instance, an operating system running on CPU 14 coordinates the interaction of processing components for applications that generate information. Visual information is communicated to graphics processor 22 for translation into display information that a display 24 receives through a graphics link 26 to present as visual images. For example, graphics processor 22 generates pixel values that define colors for the pixels of display 24, which are communicated over a graphics link using LVDS, DVI, DisplayPort or other graphics link 26.

Integrated projector 12 has a light modulator 26 that accepts display information from graphics link 26 and applies the display information to form visual images on a translucent panel, such as miniaturized LCD or a DLP. A light source 28 provides illumination through light modulator 26 into optics 30 so that an image 32 is projected distal information handling system 10. Light source 28 is, for example, an LED or laser light source. A selector 34 controlled by firmware, such as a BIOS, or an operating system selects whether to provide display information to light modulator 26 so that a visual image is generated for projection. In the example embodiment depicted by FIG. 1, light modulator 26 and display 24 share a common graphics link with graphics processor 22 generating display information at a pixel level for the selected display device. Graphics processor 22 performs scaling, color correction and brightness control functions for light modulator 26 in the place of the display controller normally used by a projector. Graphics processor 22 supports display 24 and integrated projector 12 to have separate displays of information or simultaneous display of common information. An alignment module 36 associated with graphics processor 22 alters the output of display information to perform automated corrections to image 32, such as keystone correction or correction of the image about a rotational axis.

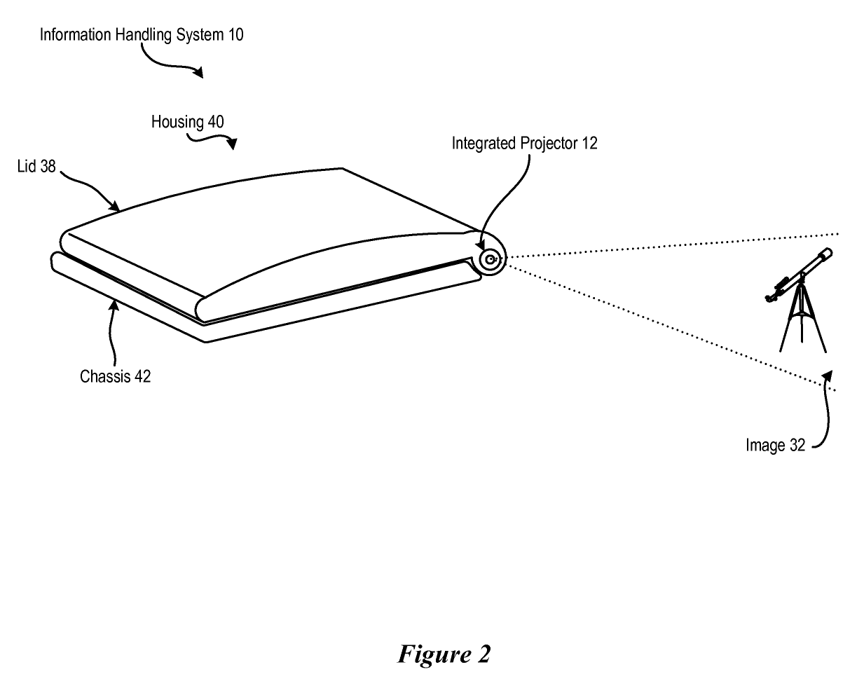

Referring now to FIG. 2, an information handling system is depicted having a projector 12 integrated at the rotational axis of a housing lid 38. Housing 40 has a chassis portion 42 that contains the processing components and a rotationally coupled lid portion 38 that supports an integrated display and integrated projector 12. Lid 38 rotates relative to chassis 42 about a horizontal axis from the closed position depicted by FIG. 2 to an open position that exposes the display integrated in lid 38. Projector 12 presents images generated by the same graphics processor of information handling system that generates images for the integrated display. An alignment module within housing 40 detects the amount of rotation made by lid 38 relative to chassis 42 to determine an offset of the image and provides the image offset to the graphics processor for a correction of the image. For example, if lid 38 rotates 90 degrees to an open position so that projector 12 also rotates 90 degrees, the alignment module has the graphics processor offset the image created at the light modulator by 90 degrees so that image 32 appears upright.

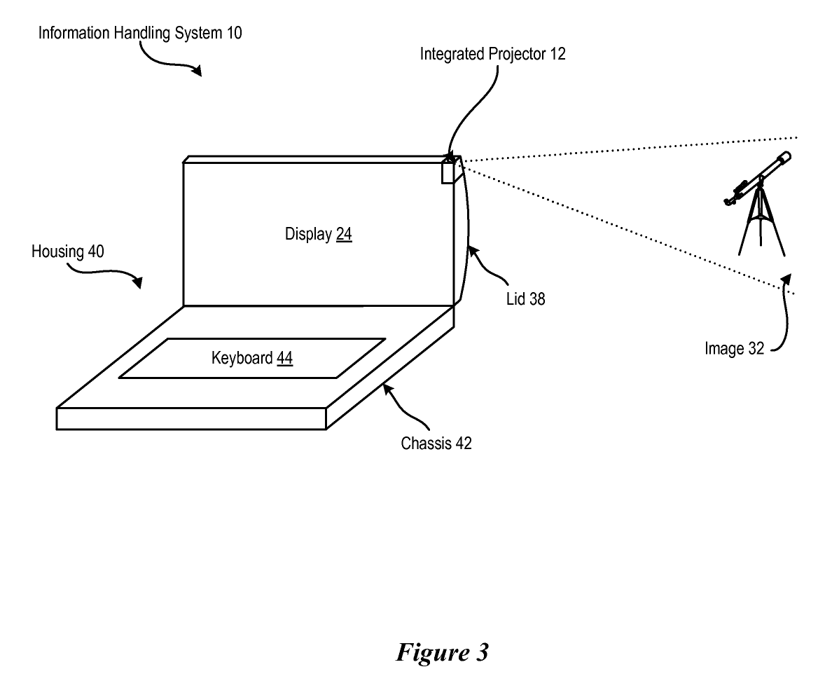

Referring now to FIG. 3, an information handling system 10 is depicted having a projector 12 integrated in a housing lid 38 distal the rotational axis. Projector 12 projects an image from the top of lid 38 when lid 38 is in an open position. Having lid 38 open relative to chassis 42 exposes a keyboard 44 so that an end user can control the image 32 presented by projector 12. An alignment module associated with projector 12 detects the angle of lid 38 relative to a perpendicular alignment so that keystone correction to image 32 can be provided by the graphics processor. In an example embodiment where projector 12 presents an image to the side of lid 38 instead of from the back of lid 38 as is depicted by FIG. 3, rotational correction is applied by the alignment module based upon the degrees to which lid 38 is open relative to chassis 42.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor disposed in the housing and operable to generate visual information;
a graphics processor disposed in the housing and interfaced with the processor, the graphics processor operable to generate display information from the visual information;
a display disposed in the housing and directly interfaced with the graphics processor, the display operable to present the display information as visual images;
a light modulator disposed in the housing and directly interfaced with the graphics processor, the light modulator operable to present the display information as visual images;
a light source disposed in the housing and aligned to illuminate through the light modulator; and
optics disposed in the housing and aligned to project light passed from the light source through the light modulator to a point distal the housing.

2. The information handling system of claim 1 wherein the light source comprises one or more lasers.

3. The information handling system of claim 1 wherein the light source comprises one or more LEDs.

4. The information handling system of claim 1 wherein the housing comprises a chassis having a rotationally coupled lid, the display integrated in the lid.

5. The information handling system of claim 4 wherein the light modulator, light source and optics are integrated in the chassis and aligned to project visual images in a predetermined direction relative to the chassis.

6. The information handling system of claim 4 wherein the light modulator, light source and optics are integrated in the lid and aligned to project visual images in a predetermined direction relative to the lid.

7. The information handling system of claim 6 further comprising an alignment module associated with the lid and operable to measure a visual image offset and to communicate the visual image offset to the graphics processor, and wherein the graphics process is further operable to apply keystone correction for the visual image offset.

8. The information handling system of claim 6 wherein the display and light modulator directly interface with the graphics processor through a common communication link.

9. The information handling system of claim 8 wherein the communication link comprises a DisplayPort link.

10. The information handling system of claim 8 wherein the communication link comprises an LVDS link.

11. A method for presenting information at an information handling system, the method comprising:
generating display information at a graphics processor of the information handling system;
communicating the display information from the graphics processor directly to a display integrated in the information handling system to present the display information as visual images at the display;
communicating the display information from the graphics processor directly to a light modulator integrated in the information handling system, the light modulator forming visual images with the display information; and
projecting light from a light source integrated in the information handling system through the light modulator and optics integrated in the information handling system to project the visual images distal to the information handling system.

12. The method of claim 11 wherein projecting light further comprises projecting light from a chassis of the information handling system.

13. The method of claim 11 wherein projecting light further comprises projecting light from a lid rotationally coupled to a chassis of the information handling system.

14. The method of claim 13 further comprising:
determining a visual image offset associated with the projecting; and
applying keystone correction to the display information with the graphics processor to compensate for the determined visual image offset.

15. The method of claim 11 wherein communicating the display information from the graphics processor directly to a light modulator further comprises communicating the display information through an LVDS link.

16. The method of claim 11 wherein communicating the display information from the graphics processor directly to a light modulator further comprises communicating the display information through a DisplayPort link.

17. The method of claim 11 wherein communicating the display information from the graphics processor directly to a light modulator further comprises communicating the display information through a DVI link.

18. A system for projecting visual images out from an information handling system, the system comprising:
a light modulator operable to interface with a display link of the information handling system to accept display information directly from a graphics processor of the information handling system;
a light source sized to fit into a chassis of the information handling system and aligned to illuminate the light modulator; and
optics sized to fit into the chassis and aligned to project light from the light source after the light passes through the light modulator.

19. The system of claim 18 wherein the display link comprises a DisplayPort link proceeding from the graphics processor to a display integrated in the information handling system.

20. The system of claim 18 wherein the graphics processor performs scaling for the light modulator.
